(19) United States
(12) Patent Application Publication
(10) Pub. No.: US 2017/0146039 A1
(43) Pub. Date: May 25, 2017

(54) SYNTHETIC JET

(71) Applicants: Inventec (Pudong) Technology Corporation, Shanghai (CN); INVENTEC CORPORATION, Taipei City (TW)

(72) Inventors: Wei-Yi LIN, TAIPEI CITY (TW); Wei-Han HO, TAIPEI CITY (TW)

(21) Appl. No.: 15/166,289

(22) Filed: May 27, 2016

(30) Foreign Application Priority Data
Nov. 20, 2015 (CN) 201510808694.6

(51) Int. Cl. F15D 1/00; F28F 13/06

(52) U.S. Cl. CPC F15D 1/0095; F28F 13/06

(57) ABSTRACT

A synthetic jet includes a casing, a vibrating membrane and a guiding channel. The casing has a chamber. The casing has an inlet and an outlet opposite to each other. The inlet and the outlet communicate with the chamber. The chamber is configured to accommodate gas. The outlet corresponds to a heat source. The vibrating membrane isolates and divides the chamber into a first subsidiary chamber and a second subsidiary chamber. The inlet communicates with the first subsidiary chamber. The second subsidiary chamber has a second subsidiary chamber opening communicating with the outlet. The guiding channel communicates with the first subsidiary chamber and the outlet. When being driven, the vibrating membrane reciprocally deforms towards the first subsidiary chamber and the second subsidiary chamber.

### RELATED APPLICATIONS

This application claims priority to Chinese Application Serial Number 201510808694.6, filed Nov. 20, 2015, which is herein incorporated by reference.

### BACKGROUND

Technical Field

The present disclosure relates to a synthetic jet.

Description of Related Art

In fluid dynamics, a synthetic jet is a technique of converting the surrounding fluid into a fluid jet. In general, the synthetic jet sucks in the surrounding gas, and then pressurizes the and injects the gas, in which the ambient gas is driven to flow along with the injected gas, thereby achieving a heat dissipation effect to a target heat source.

Hence, in order to increase the heat dissipation to the target heat source by using the synthetic jet, how to suck and inject gas which is located away from the target heat source onto the target heat source is undoubtedly an important direction of research and development in the industry.

### SUMMARY

A technical aspect of the present disclosure is to provide a synthetic jet, which can suck in the gas which is located away from a heat source when injecting gas on the heat source for heat dissipation, thereby enhancing the heat dissipation effect to the heat source.

According to an embodiment of the present disclosure, a synthetic jet includes a casing, a vibrating membrane and a guiding channel. The casing has a chamber. The casing has an inlet and an outlet opposite to each other. The inlet and the outlet communicate with the chamber. The chamber is configured to accommodate gas. The outlet corresponds to a heat source. The vibrating membrane Isolates and divides the chamber into a first subsidiary chamber and a second subsidiary chamber. The inlet communicates with the first subsidiary chamber. The second subsidiary chamber has a second subsidiary chamber opening communicating with the outlet. The guiding channel communicates with the first subsidiary chamber and the outlet. When being driven, the vibrating membrane reciprocally deforms towards the first subsidiary chamber and the second subsidiary chamber.

In one or more embodiments of the present disclosure, the synthetic jet further includes a pivot door. The pivot door is disposed at an end of the guiding channel communicating with the outlet. When the vibrating membrane deforms towards the second subsidiary chamber, the pivot door blocks communication between the guiding channel and the second subsidiary chamber opening.

In one or more embodiments of the present disclosure, the synthetic jet further includes a pivot door. The pivot door is disposed at an end of the guiding channel communicating with the outlet. When the vibrating membrane deforms towards the first subsidiary chamber, the pivot door is opened to enable communication between the guiding channel and the second subsidiary chamber opening.

In one or more embodiments of the present disclosure, the vibrating membrane is a piezoelectric film.

In one or more embodiments of the present disclosure, the guiding channel has a guiding channel inlet and a guiding channel outlet. The guiding channel inlet communicates with the first subsidiary chamber. The guiding channel outlet communicates with the second subsidiary chamber opening. A position of the guiding channel inlet substantially corresponds to a center of the vibrating membrane. The synthetic jet further includes a pivot door disposed at the guiding channel outlet.

In one or more embodiments of the present disclosure, the casing further has at least one guiding slant surface. Two ends of the guiding slant surface are respectively connected with the outlet and the second subsidiary chamber.

In one or more embodiments of the present disclosure, the first subsidiary chamber has a first subsidiary chamber opening facing the guiding slant surface, and the second subsidiary chamber opening faces the guiding slant surface.

In one or more embodiments of the present disclosure, a normal direction of the first subsidiary chamber opening substantially intersects with a normal direction of the second subsidiary chamber opening.

In one or more embodiments of the present disclosure, the synthetic jet further includes a driving unit. The driving unit is configured to drive the vibrating membrane.

In one or more embodiments of the present disclosure, the vibrating membrane is a magnetic membrane. The driving unit includes an electromagnetic coil. The electromagnetic coil is configured to generate an alternating current (AC) magnetic field to drive the vibrating membrane.

When compared with the prior art, the above-mentioned embodiments of the present disclosure have at least the following advantages:

(1) Since the inlet and the outlet of the casing are opposite to each other, the outlet corresponding to the heat source means that the inlet is located away from the heat source. Because the heat source heats up the gas nearby easily, the inlet located away from the heat source can prevent the synthetic jet from sucking in the gas heated up by the heat source. In this way, the gas which is continuously sucked into the synthetic jet is not the gas heated up by the heat source. Therefore, the injected gas continuously injected from the synthetic jet towards the heat source does not carry any heat from the heat source. As a result, the heat dissipation effect to the heat source by the synthetic jet is effectively enhanced.

(2) When the gas accommodated in the first subsidiary chamber is squeezed and flows to the guiding channel, since the position of the guiding channel inlet substantially corresponds to the center of the vibrating membrane, the gas accommodated in the first subsidiary chamber is squeezed and flows to the guiding channel more easily. Thus, the operating process of the synthetic jet becomes relatively smooth.

(3) Since the casing further has at least one guiding slant surface. Two ends of the guiding slant surface are respectively connected with the outlet and the second subsidiary chamber. The first subsidiary chamber opening faces towards the guiding slant surface, and the second subsidiary chamber opening faces towards the guiding slant surface. In other words, the normal direction of the first subsidiary chamber opening substantially intersects with the normal direction of the second subsidiary chamber opening. In this way, the guiding slant surface can smoothly guide the gas from the first subsidiary chamber opening to the second subsidiary chamber opening.

### BRIEF DESCRIPTION OF THE DRAWINGS

The disclosure can be more fully understood by reading the following detailed description of the embodiments, with reference made to the accompanying drawings as follows:

FIG. 1 is a schematic cross-sectional view of a synthetic jet according to an embodiment of the present disclosure;

FIG. 2 is a schematic cross-sectional view of the synthetic jet of FIG. 1, in which a vibrating membrane deforms towards a first subsidiary chamber;

FIG. 3 is a schematic cross-sectional view of the synthetic jet of FIG. 1, in which the vibrating membrane deforms towards a second subsidiary chamber; and

FIG. 4 is a schematic cross-sectional view of a synthetic jet according to another embodiment of the present disclosure, in which the synthetic jet further includes a driving unit.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

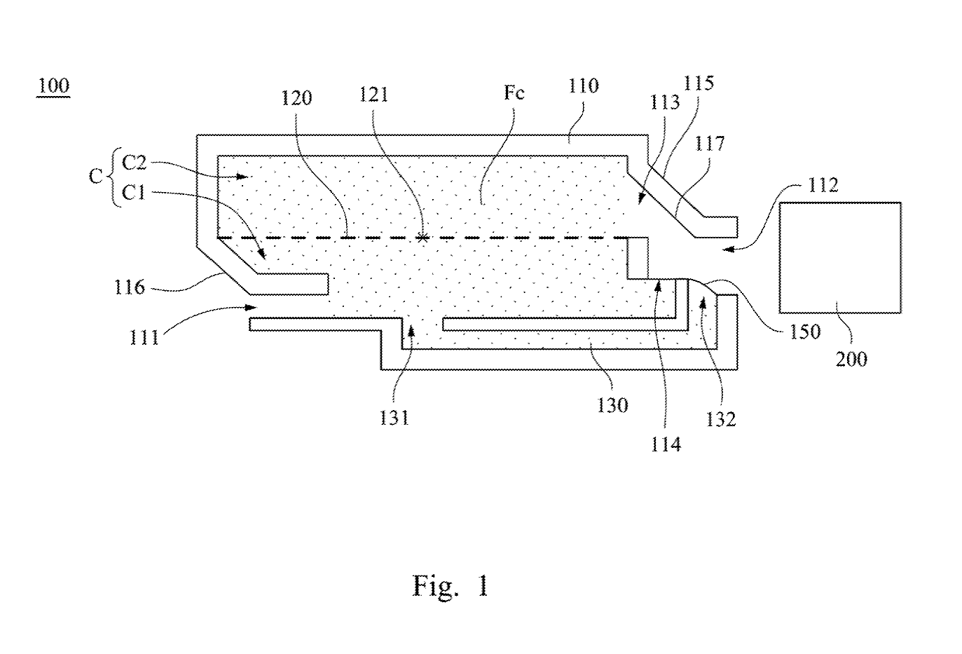

Reference is made to FIG. 1. FIG. 1 is a schematic cross-sectional view of a synthetic jet 100 according to an embodiment of the present disclosure. As shown in FIG. 1, a synthetic jet 100 includes a casing 110, a vibrating membrane 120 and a guiding channel 130. The casing 110 has a chamber C. The casing 110 has an inlet 111 and an outlet 112 opposite to each other. The inlet 111 and the outlet 112 communicate with the chamber C. The chamber C is configured to accommodate gas Fc. The outlet 112 corresponds to a heat source 200. The vibrating membrane 120 isolates and divides the chamber C into a first subsidiary chamber C1 and a second subsidiary chamber C2. The inlet 111 communicates with the first subsidiary chamber C1. The second subsidiary chamber C2 has a second subsidiary chamber opening 113. The second subsidiary chamber opening 113 communicates with the outlet 112. The guiding channel 130 communicates with the first subsidiary chamber C1 and the outlet 112. When being driven, the vibrating membrane 120 reciprocally deforms towards the first subsidiary chamber C1 and the second subsidiary chamber C2. In practical applications, the vibrating membrane 120 may be a piezoelectric film.

In addition, the synthetic jet 100 further includes a pivot door 150. The pivot door 150 is disposed at an end of the guiding channel 130 communicating with the outlet 112, so as to allow the gas Fc to flow from the guiding channel 130 to the second subsidiary chamber opening 113, and prevent the gas Fc from flowing to the guiding channel 130 from the second subsidiary chamber opening 113. To be more specific, when the vibrating membrane 120 deforms towards the second subsidiary chamber C2, the pivot door 150 blocks the communication between the guiding channel 130 and the second subsidiary chamber opening 113. On the other hand, when the vibrating membrane 120 deforms towards the first subsidiary chamber C1, the pivot door 150 is opened to enable the communication between the guiding channel 130 and the second subsidiary chamber opening 113.

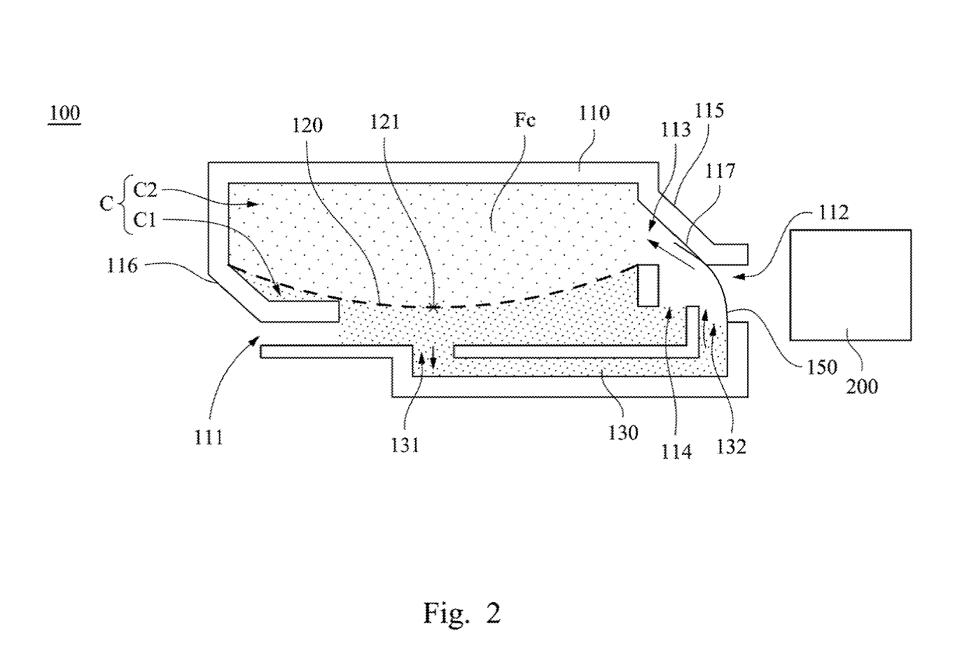

Reference is made to FIG. 2. FIG. 2 is a schematic cross-sectional view of the synthetic jet 100 of FIG. 1, in which the vibrating membrane 120 deforms towards the first subsidiary chamber C1. As shown in FIG. 2, the vibrating membrane 120 is driven to deform towards the first subsidiary chamber C1, such that the space of the first subsidiary chamber C1 is reduced. Thus, the pressure in the first subsidiary chamber C1 is increased. On the contrary, the deformation of the vibrating membrane 120 towards the first subsidiary chamber C1 increases the space of the second subsidiary chamber C2. Thus, the pressure in the second subsidiary chamber C2 is decreased. Consequently, the pressure in the first subsidiary chamber C1 is higher than the pressure in the second subsidiary chamber C2 and thus the pivot door 150 is opened, thereby enabling the communication between the guiding channel 130 and the second subsidiary chamber opening 113. At this point, the gas Fc (such as air in this embodiment) accommodated in the first subsidiary chamber C1 of a relatively higher pressure is squeezed and flows to the guiding channel 130. Since the pressure in the second subsidiary chamber C2 is lower than that in the first subsidiary chamber C1, the second subsidiary chamber C2 tends to suck in the gas Fc. In this way, the gas Fc flows to the second subsidiary chamber opening 113 through the guiding channel 130, and then enters into and is stored in the second subsidiary chamber C2 of a relatively lower pressure through the second subsidiary chamber opening 113.

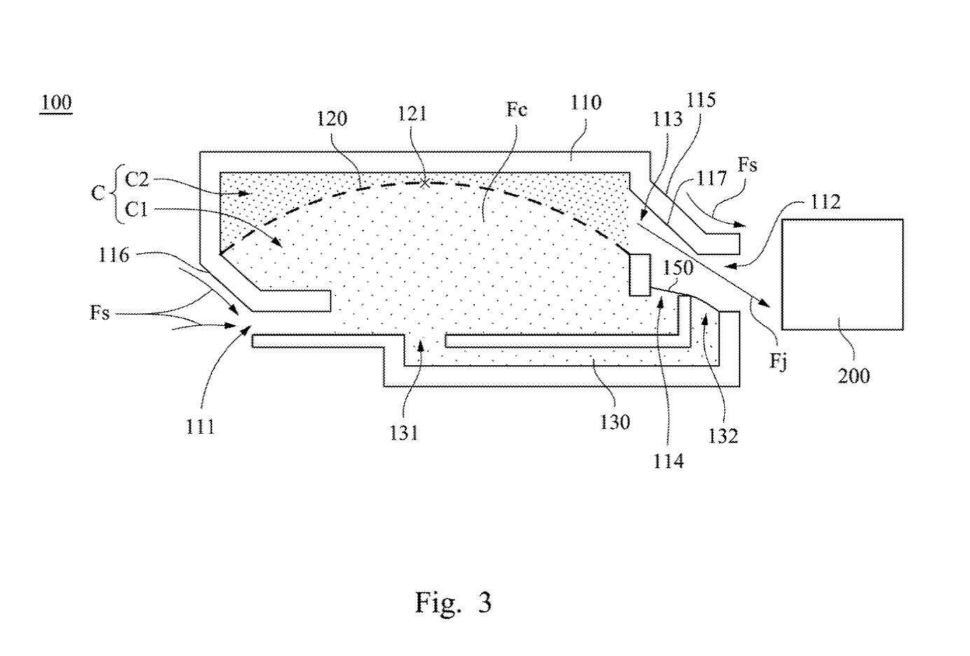

Reference is made to FIG. 3. FIG. 3 is a schematic-cross sectional view of the synthetic jet 100 of FIG. 1, in which the vibrating membrane 120 deforms towards the second subsidiary chamber C2. As shown in FIG. 3, the vibrating membrane 120 is driven to deform towards the second subsidiary chamber C2, such that the space of the second subsidiary chamber C2 is reduced, and thus the pressure in the second subsidiary chamber C2 is increased. On the contrary, the deformation of the vibrating membrane 120 towards the second subsidiary chamber C2 increases the space of the first subsidiary chamber C1, and thus, the pressure in the first subsidiary chamber C1 is decreased. Consequently, the pressure in the second subsidiary chamber C2 is higher than the pressure in the first subsidiary chamber C1, and thus, the pivot door 150 is closed. At this point, the aforementioned gas Fc entering into and stored in the second subsidiary chamber C2 from the first subsidiary chamber C1, is squeezed and flows to the second subsidiary chamber opening 113 because of the increase of the pressure in the second subsidiary chamber C2. Since the pivot door 150 is closed at this point, the communication between the guiding channel 130 and the second subsidiary chamber opening 113 is blocked, and the gas Fc in the second subsidiary chamber C2 cannot enter into the first subsidiary chamber C1. Instead, the gas Fc is squeezed and flows to the outlet 112 through the second subsidiary chamber opening 113, and then becomes injection gas Fj injected towards the heat source 200 through the outlet 112. Consequently, the heat dissipation effect is produced for the heat source 200.

Meanwhile, as described above, because the deformation of the vibrating membrane 120 towards the second subsidiary chamber C2 causes the reduction of the pressure in the first subsidiary chamber C1, in addition to causing the pivot door 150 to be closed, the gas Fs surrounding the inlet 111 and located outside the synthetic jet 100 is also sucked into the first subsidiary chamber C1 of a reduced pressure through the inlet 111. In this way, the gas Fs surrounding the inlet 111 and located outside the synthetic jet 100 is accommodated in the first subsidiary chamber C1 and becomes the gas Fc.

Please refer back to FIG. 2. At this point, the vibrating membrane 120 deforms towards the first subsidiary chamber C1 again. As described above, the gas Fc accommodated in the first subsidiary chamber C1 with a relatively higher pressure is squeezed and flows to the guiding channel 130. Since the pressure in the second subsidiary chamber C2 is lower than the pressure in the first subsidiary chamber C1, the pivot door 150 is opened again and enables the communication between the guiding channel 130 and the second subsidiary chamber opening 113. Thus, the second subsidiary chamber C2 tends to suck in the gas Fc. In this way, the gas Fc flows to the second subsidiary chamber opening 113 through the guiding channel 130, and then enters into and is stored in the second subsidiary chamber C2 of a relatively lower pressure through the second subsidiary chamber opening 113. As a result, when the synthetic jet 100 operates, the vibrating membrane 120 reciprocally deforms towards the first subsidiary chamber C1 and the second subsidiary chamber C2. The gas Fs surrounding the inlet 111 and located outside the synthetic jet 100 is continuously sucked into the casing 110 of the synthetic jet 100 to become the gas Fc, and is continuously squeezed and flows to the outlet 112 from the casing 110 of the synthetic jet 100, and then becomes the injection gas Fj injected towards the heat source 200 through the outlet 112. Consequently, the heat dissipation effect is produced for the heat source 200.

In addition, as described above, since the inlet 111 and the outlet 112 of the casing 110 are opposite to each other, the outlet 112 corresponding to the heat source 200 means that the inlet 111 is located away from the heat source 200. Because the heat source 200 heats up the gas Fs nearby easily, the inlet 111 located away from the heat source 200 can prevent the synthetic jet 100 from sucking in the gas Fs heated up by the heat source 200. In this way, the gas Fs which is continuously sucked into the synthetic jet 100 is not the gas Fs heated up by the heat source 200. Therefore, the injected gas Fj continuously injected from the synthetic jet 100 towards the heat source 200 does not carry any heat from the heat source 200. As a result, the heat dissipation effect to the heat source 200 by the synthetic jet 100 is effectively enhanced.

To be more specific, as shown in FIGS. 1-3, the guiding channel 130 has a guiding channel inlet 131 and a guiding channel outlet 132. The guiding channel inlet 131 communicates with the first subsidiary chamber C1. The guiding channel outlet 132 communicates with the second subsidiary chamber opening 113. A position of the guiding channel inlet 131 substantially corresponds to a center 121 of the vibrating membrane 120, and the pivot door 150 is disposed at the guiding channel outlet 132. When the vibrating membrane 120 is driven to deform towards the first subsidiary chamber C1, as described above, the gas Fc accommodated in the first subsidiary chamber C1 is squeezed and flows to the guiding channel 130. Since the position of the guiding channel inlet 131 substantially corresponds to the center 121 of the vibrating membrane 120, the gas Fc accommodated in the first subsidiary chamber C1 is squeezed and flows to the guiding channel 130 more easily. Thus, the operating process of the synthetic jet 100 becomes relatively smooth.

In addition, as shown in FIGS. 1-3, the casing 110 further has at least one guiding slant surface 117. Two ends of the guiding slant surface 117 are respectively connected with the outlet 112 and the second subsidiary chamber C2. The first subsidiary chamber opening 114 faces towards the guiding slant surface 117, and the second subsidiary chamber opening 113 faces towards the guiding slant surface 117. In other words, a normal direction of the first subsidiary chamber opening 114 substantially intersects with a normal direction of the second subsidiary chamber opening 113. In this way, the guiding slant surface 117 can smoothly guide the gas Fc from the first subsidiary chamber opening 114 to the second subsidiary chamber opening 113.

When the gas Fc is injected towards the heat source 200 as the injection gas Fj through the outlet 112, the gas Fs surrounding the outlet 112 and located outside the synthetic jet 100 is driven by the injection gas Fj to flow towards the heat source 200 along with the injection gas Fj. In this way, the heat dissipation effect to the heat source 200 is enhanced. As shown in FIGS. 1-3, the casing 110 further has at least one first streamlined surface 115. The first streamlined surface 115 is adjacent to the outlet 112, such that the gas Fs surrounding the outlet 112 and located outside the synthetic jet 100 can flow along with the injection gas Fj, and can be injected from the synthetic jet 100 towards the heat source 200 more smoothly, thereby further enhancing the heat dissipation effect of the synthetic jet 100 to the heat source 200.

On the other hand, as shown in FIGS. 1-3, the casing 110 further has at least one second streamlined surface 116. The second streamlined surface 116 is adjacent to the inlet 111, such that the gas Fs surrounding the inlet 111 and located outside the synthetic jet 100 can be sucked into the first subsidiary chamber C1 through the inlet 111 more smoothly.

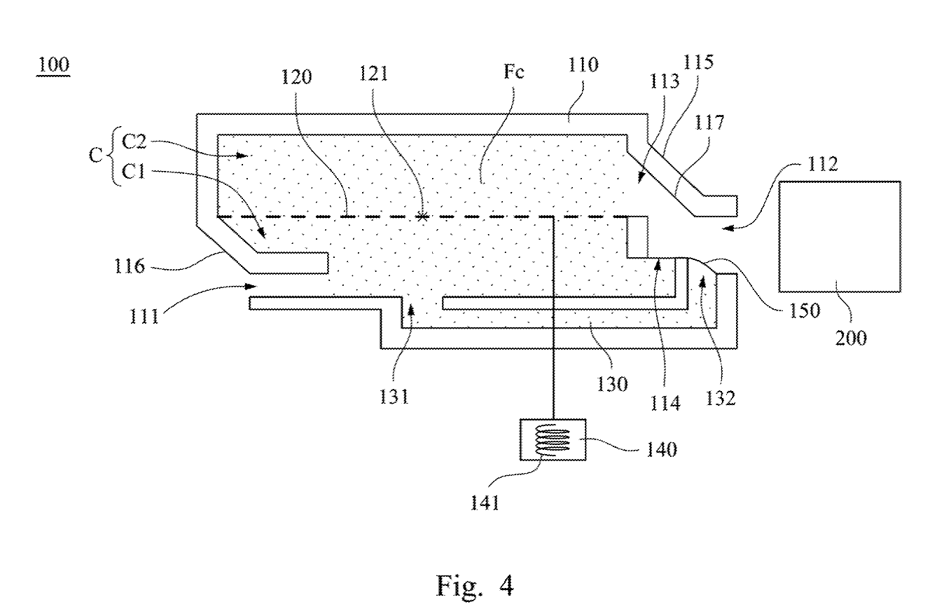

Reference is made to FIG. 4. FIG. 4 is a schematic cross-sectional view of a synthetic jet 100 according to another embodiment of the present disclosure, in which the synthetic jet 100 further includes a driving unit 140. As shown in FIG. 4, the synthetic jet 100 includes the casing 110, the vibrating membrane 120 and the guiding channel 130, the pivot door 150 and a driving unit 140. The casing 110 has the chamber C. The casing 110 has the inlet 111 and the outlet 112 opposite to each other. The inlet 111 and the outlet 112 communicate with the chamber C. The chamber C is configured to accommodate the gas Fc. The outlet 112 corresponds to the heat source 200. The vibrating membrane 120 isolates and divides the chamber C into the first subsidiary chamber C1 and the second subsidiary chamber C2. The inlet 111 communicates with the first subsidiary chamber C1. The second subsidiary chamber C2 has the second subsidiary chamber opening 113. The second subsidiary chamber opening 113 communicates with the outlet 112. The guiding channel 130 communicates with the first subsidiary chamber C1 and the second subsidiary chamber opening 113. The pivot door 150 is disposed at the end of the guiding channel 130 communicating with the second subsidiary chamber opening 113, so as to allow the gas Fc to flow from the guiding channel 130 to the second subsidiary chamber opening 113, and prevent the gas Fc from flowing to the guiding channel 130 from the second subsidiary chamber opening 113. The driving unit 140 is configured to drive the vibrating membrane 120 to reciprocally deform towards the first subsidiary chamber C1 and the second subsidiary chamber C2. In the practical applications of this embodiment, the vibrating membrane 120 is a magnetic membrane. The driving unit 140 includes an electromagnetic coil 141. The electromagnetic coil 141 is configured to generate an alternating current (AC) magnetic field to drive the magnetic membrane.

In practical applications, the driving unit 140 can apply various operating modes such as an electromagnetic mode, a piezoelectric mode or a mechanical mode, to drive the vibrating membrane 120 to reciprocally deform towards the first subsidiary chamber C1 and the second subsidiary chamber C2. However, such operating modes do not intend to limit the present disclosure.

In conclusion, when compared with the prior art, the aforementioned embodiments of the present disclosure have at least the following advantages.

(1) Since the inlet and the outlet of the casing are opposite to each other, the outlet corresponding to the heat source means that the inlet is located away from the heat source. Because the heat source heats up the gas nearby easily, the inlet located away from the heat source can prevent the synthetic jet from sucking in the gas heated up by the heat source. In this way, the gas which is continuously sucked into the synthetic jet is not the gas heated up by the heat source. Therefore, the injected gas continuously injected from the synthetic jet towards the heat source does not carry any heat from the heat source. As a result, the heat dissipation effect to the heat source by the synthetic jet is effectively enhanced.

(2) When the gas accommodated in the first subsidiary chamber is squeezed and flows to the guiding channel, since the position of the guiding channel inlet substantially corresponds to the center of the vibrating membrane, the gas accommodated in the first subsidiary chamber is squeezed and flows to the guiding channel more easily. Thus, the operating process of the synthetic jet becomes relatively smooth.

(3) Since the casing further has at least one guiding slant surface. Two ends of the guiding slant surface are respectively connected with the outlet and the second subsidiary chamber. The first subsidiary chamber opening faces towards the guiding slant surface, and the second subsidiary chamber opening faces towards the guiding slant surface. In other words, the normal direction of the first subsidiary chamber opening substantially intersects with the normal direction of the second subsidiary chamber opening. In this way the guiding slant surface can smoothly guide the gas from the first subsidiary chamber opening to the second subsidiary chamber opening.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A synthetic jet, comprising:
a casing having a chamber, the casing having an inlet and an outlet opposite to each other, the inlet and the outlet communicating with the chamber, the chamber being configured to accommodate gas, the outlet corresponding to a heat source;
a vibrating membrane isolating and dividing the chamber into a first subsidiary chamber and a second subsidiary chamber, the inlet communicating with the first subsidiary chamber, the second subsidiary chamber having a second subsidiary chamber opening communicating with the outlet; and
a guiding channel communicating with the first subsidiary chamber and the outlet;
wherein when being driven, the vibrating membrane reciprocally deforms towards the first subsidiary chamber and the second subsidiary chamber.

2. The synthetic jet of claim 1, further comprising a pivot door disposed at an end of the guiding channel communicating with the outlet, wherein when the vibrating membrane deforms towards the second subsidiary chamber, the pivot door blocks communication between the guiding channel and the second subsidiary chamber opening.

3. The synthetic jet of claim 1, further comprising a pivot door disposed at an end of the guiding channel communicating with the outlet, wherein when the vibrating membrane deforms towards the first subsidiary chamber, the pivot door is opened to enable communication between the guiding channel and the second subsidiary chamber opening.

4. The synthetic jet of claim herein the vibrating membrane is a piezoelectric film.

5. The synthetic jet of claim 1, wherein the guiding channel has a guiding channel inlet and a guiding channel outlet, the guiding channel inlet communicating the first subsidiary chamber, the guiding channel outlet communicating with the second subsidiary chamber opening, a position of the guiding channel inlet substantially corresponding to a center of the vibrating membrane, the synthetic jet further comprising a pivot door disposed at the guiding channel outlet.

6. The synthetic jet of claim 1, wherein the casing further has at least one guiding slant surface, two ends of the guiding slant surface are respectively connected with the outlet and the second subsidiary chamber.

7. The synthetic jet of claim 6, wherein the first subsidiary chamber has a first subsidiary chamber opening facing the guiding slant surface, and the second subsidiary chamber opening faces the guiding slant surface.

8. The synthetic jet of claim 7, wherein a normal direction of the first subsidiary chamber opening substantially intersects with a normal direction of the second subsidiary chamber opening.

9. The synthetic jet of claim 1, further comprising a driving unit configured to drive the vibrating membrane.

10. The synthetic jet of claim 9, wherein the vibrating membrane is a magnetic membrane, and the driving unit comprises an electromagnetic coil configured to generate an alternating current (AC) magnetic field to drive the vibrating membrane.
